(19) United States
(12) Patent Application Publication
(10) Pub. No.: US 2020/0214481 A1
(43) Pub. Date: Jul. 9, 2020

(54) CUSTOMIZABLE, MODULAR, CERVICAL TRACTION MULTIPLE-USE PILLOW

(71) Applicant: Robert M. Sexton, Cedar Park, TX (US)

(72) Inventor: Robert M. Sexton, Cedar Park, TX (US)

(21) Appl. No.: 16/736,496

(22) Filed: Jan. 7, 2020

Related U.S. Application Data
(60) Provisional application No. 62/789,108, filed on Jan. 7, 2019.

(51) Int. Cl. A47G 9/10; A61H 1/00; A61H 39/04

(52) U.S. Cl. CPC A47G 9/1081; A61H 1/00; A61H 2205/04; A47G 2009/1018; A61H 2201/0134; A61H 39/04

(57) ABSTRACT

A modifiable pillow having a main pillow module, which serves as the foundation or base for the application of other modules adapted for various purposes is provided. A mechanical traction assembly may also be operatively associated with the main pillow module for apply mechanical traction to a user of the main pillow module.

### CROSS-REFERENCE TO RELATED APPLICATION

This application claims the benefit of priority of U.S. provisional application No. 62/789,108, filed 7 Jan. 2019, the contents of which are herein incorporated by reference.

### BACKGROUND OF THE INVENTION

The present invention relates to pillows and, more particularly, a customizable, modular, cervical mechanical traction, multiple-use pillow.

Most traditional pillows are shaped in an oval design. Some have a wave type design. These shapes often force the user's head into positions that do not allow full relaxation of the muscles, which maintains tension on tendons, ligaments, etc., causing more harm than good. They also do not fit a wide range of body types, sizes, and shapes, and they do not allow for various sleep styles. They place unnecessary pressure on the ear and create heat build-up, sores, and hot spots.

As a result, in almost all cases, traditional pillows do not fit the individual user properly. Specifically, they do not allow the user to completely relax and achieve the deepest most restorative levels of sleep for long periods of time, and so such pillows can undermine good sleep.

Additionally, such pillows may promote pain and stiffness, contribute to sleep apnea as well as negative postural changes. Furthermore, current pillows also compress the ear and trap heat in the ear contributing to general discomfort, ear infections, hot spots, and bed sores. Moreover, current pillows also do not allow the user to apply mechanical traction while they sleep. Thus, current pillows do not enable the user to treat aches, pains, poor posture, and issues that cause these problems.

Pain and discomfort can result from poor posture, injuries, herniated disc, spinal stenosis, disc compression, and other such maladies. Pillows can be a great source of pain relief and comfort for such maladies; unfortunately, to date, pillows are typically one size fits all with little to no ability to customize their size or shape to the user's unique body. Almost all pillows consist of various pieces of foam or feathers sewn inside of a case. Some consist of one solid piece of memory foam in some specific shape. No pillow allows the user to adjust it to fit the size and shape of their body, and also take into consideration their sleep style (back, side, etc.).

As can be seen, there is a need for a customizable, modular, cervical mechanical traction, multiple-use pillow able to be modified, by the user, to fit the user's unique body size and shape, facilitating improved sleep quality by allowing the user to achieve a higher level of relaxation. Additionally, the present invention can also be used for relief from pain through proper positioning and alignment of the user's spine, and also enabling gentle continuous cervical mechanical traction for users during sleep, should the user desire this. The pillow embodied by the present invention is completely customizable to the size and shape of each individual user.

This invention allows the user to design their own custom pillow to achieve a higher level of comfort for relaxation and deeper, more restorative sleep. The modular design provides the user the ability to custom fit the size, and shape of the pillow to their own body. The design also allows the user to customize the pillow to their sleep style whether they sleep on their back, side, or both. The addition of various treatment modules, including the mechanical traction assembly, also allows the user to treat ailments, improve posture, and potentially relieve pain. The built-in ear niches/cutouts help to align the head and reduce the pressure and heat buildup in and around the ear.

Its modular design includes a plurality of different modules that can be combined in an infinite number of ways to allow full customization by the end user. They can customize the pillow to their shape, size, and sleep style, including combinations of sleep styles. No other pillow has ever allowed this. The user also has the option of adding additional optional modules that allow for specific functions such as mechanical traction, vibration massage, and acupressure. The pillow will also allow for the addition of future modules.

### SUMMARY OF THE INVENTION

In one aspect of the present invention, a customizable pillow for combining pillow modules: a main pillow module having an upper surface extending longitudinally between two ends and between a proximal edge and a distal edge; a head cutout communicating with the proximal edge, the head cutout dimensioned to receive a human head; and one or more ear cutouts along the upper surface on each side of the head cutout.

In another aspect of the present invention, the customizable pillow for combining pillow modules and providing neck and spine treatment applications includes the following: a main pillow module having an upper surface extending longitudinally between two ends and between a proximal edge and a distal edge; a head cutout communicating with the proximal edge, the head cutout dimensioned to receive a human head; one or more ear cutouts along the upper surface on each side of the head cutout; a plurality of modules dimensioned to be securely received in the head cutout, wherein the plurality of modules include an acupressure module and a vibration module, wherein the acupressure module provides acupressure nodes along a proximal edge thereof; one or more cervical modules dimensioned to be securely received in the head cutout, whereby the one or more cervical modules protrude above the upper surface of the main pillow module; two or more side modules and one or more rear modules, each side module and rear module providing at least one side or rear ear cutout; a mechanical traction assembly for operatively associating the main pillow module for providing mechanical traction to a human user laying a head in the head cutout or on one or more cervical modules; and a cool mesh cover dimensioned to envelope the main pillow module so as to provide mesh sections along a periphery of each ear cutout, the head cutout, and both ends of the main pillow module, respectively.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of a main module 10 of the present invention;

FIG. 2 is a perspective view of an exemplary embodiment of the main module 10 of the present invention with modules 18, 20, 22, and 26 added;

FIG. 3 is a perspective view of an exemplary embodiment of the main module 10 of the present invention with modules 30, 32, and 36 added;

FIG. 4 is an exploded perspective view of an exemplary embodiment of a plurality of modules of the present invention;

FIG. 5 is a perspective view of an exemplary embodiment of an acupressure module 40 added to modules 10, 18, and 20 of the present invention;

FIG. 6 is a perspective view of an exemplary embodiment of a mechanical traction module 44 of the present invention, shown in use;

FIG. 7 is a perspective view of an exemplary embodiment of the vibration module 66 of the present invention added to modules 10 and 20;

FIG. 8 is a top perspective view of an exemplary embodiment of the main module 10 of the present invention in a stretch pillowcase 70;

FIG. 9 is a bottom perspective view of an exemplary embodiment of the main module 10 of the present invention in the stretch pillowcase 70;

FIG. 10 is a top perspective view of an exemplary embodiment of the main module 10 of the present invention in a cool mesh cover 76; and

FIG. 11 is a bottom perspective view of an exemplary embodiment of the main module 10 of the present invention in the cool mesh cover 76.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a modifiable pillow comprising a main pillow module, which serves as the foundation or base for the application of other modules adapted for various purposes. A mechanical traction assembly may also be operatively associated with the main pillow module for apply mechanical traction to a user of the main pillow module.

It should be understood by those skilled in the art that the use of directional terms such as upper, lower, upward, downwardly, top, left, right and the like are used in relation to the illustrative embodiments as they are depicted in the figures, the upward direction (or upper) being toward the top of the corresponding figures, and the downward direction being toward the bottom of the corresponding figures.

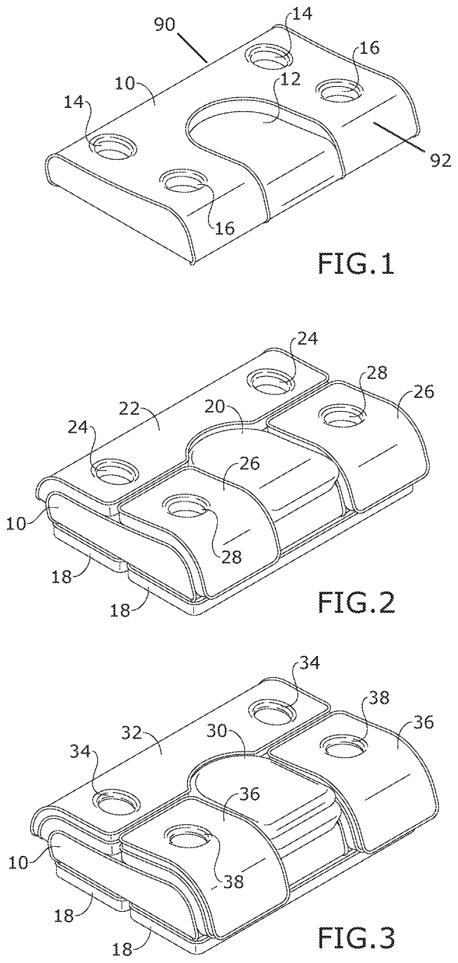

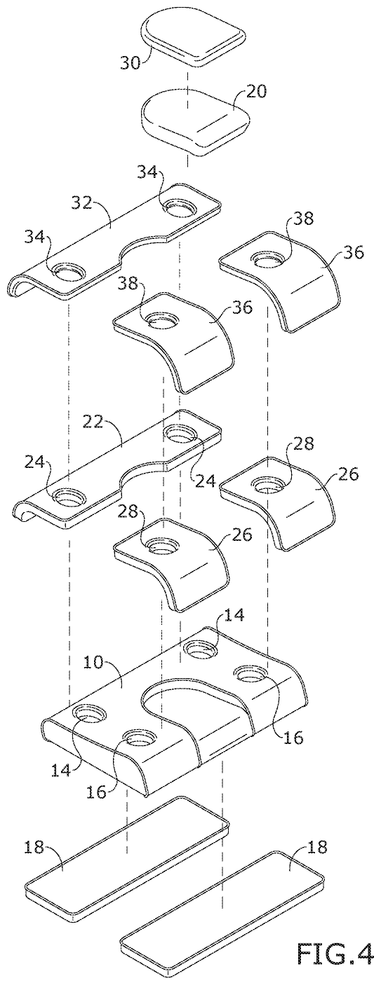

Referring now to FIGS. 1 through 11, the present invention may include a unique modifiable pillow comprising a main pillow module. The main module 10 serves as the foundation or base for the application of the other modules, including: a first cervical module 20, a second cervical module 30, an acupressure module 40, and a vibration module 66 Moreover, the present invention may include a mechanical traction assembly 44 that operatively associates with the main module 10 to enable mechanical traction for a user 64. The modules 10, 18, 20, 22, 26, 30, 32, 36, 40 and 66 may include molded foam and can be made to various lengths and widths. The foam can vary in density and include many types of materials including but not limited to polyurethane, gel infused memory foam, and synthetic foams, thus achieving various amounts and combinations of pressure relief, rebound, heat diffusion, and support. The molded foam may then covered with a natural, or synthetic, material to protect the foam and provide a surface for the application of the attachment elements, such as hook and loop, to allow for the attachment of modules 18, 20, 22, 26, 30, 40 and 66.

Referring to FIG. 1, the main module 10 provides an upper surface and a lower surface that define a longitudinal length of the main module 10 that extends from a first end to an opposing second end. A distal edge 90 of the top surface has a distal curvature defined in part by a first radius. The proximal edge 92 of the top surface has a proximal curvature defined in part by a proximal radius that is greater than the distal radius, and the proximal curvature is less circular than the first curvature. The upper surface provides a centrally disposed head cutout 12, dimensioned and adapted to receive a lower portion a user's head. On both sides of the head cutout 12 may be proximal ear cutouts 16 and distal ear cutouts 14, dimensioned and adapted to receive an ear of said user.

The first cervical module 20 may have a first thickness and be dimensioned and adapted to be received in the head cutout 12 so that an upper surface of the first cervical module 20 is generally flush with the upper surface of the main module 10. The first cervical module 20 may include two first side modules 26 that have generally the same first thickness, each providing a first proximal ear cutout 28 along the upper surface, respectively. The first cervical module 20 may share the first thickness and include a first rear module 22, providing two distal ear cutouts 24 along the upper surface. The lower surfaces of the first rear module 22 and the two first side modules 26 are dimensioned and adapted conform to the distal curvature and the proximal curvature respectively. The first thickness may be approximately one and one-half to two and one-half inches in thickness.

Referring to FIG. 3, the second cervical module 30 may have a second thickness and be dimensioned and adapted to be received in the head cutout 12 or over the first cervical module 20, so that an upper surface of the second cervical module 30 is elevated above the upper surface of the main module 10 by a second distance when stacked on the first cervical module and below the upper surface of the main module 10 if received in the head cutout 12 without the first cervical module 20. The second cervical module 30 may include two second side modules 36 that have generally the same second thickness, each providing a second proximal ear cutout 38 along the upper surface, respectively. The second cervical module 30 may share the second thickness and include a second rear module 32, providing two distal ear cutouts 34 along the upper surface. The lower surfaces of the second rear module 32 and the two second side modules 36 are dimensioned and adapted conform to the proximal curvature and the distal curvature respectively. The second thickness may be approximately three-quarters to one and a half inch in thickness.

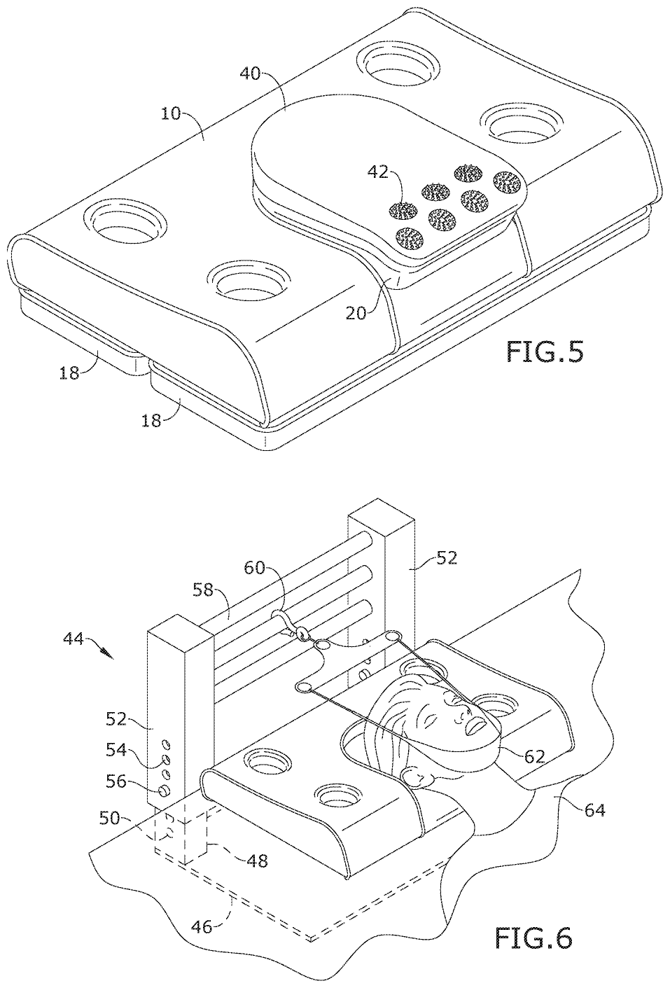

Referring to FIG. 5, the acupressure module 40 may be dimensioned and adapted to be received in the head cutout 12 or over the first cervical module 20 and/or the second cervical module 30. A proximal edge of an upper surface of the acupressure module 40 may include acupressure nodes 42.

The base lift module 18 may be attached along the lower surface of the main module 10 using various attachment elements, such as hook and loop fasteners. The base lift module 18 may be approximately three-quarters to one and a half inch in thickness.

Referring to FIG. 6, a mechanical traction assembly 44 may be adapted and positioned by the user 64 to achieve proper alignment of their head and neck to allow for a more comfortable sleep, and relief of pain and stiffness due to improper positioning, injury, poor posture, disease, stress or other issues. The mechanical traction assembly 44 may operatively associate with the main pillow module 10 so as to provide gentle mechanical traction to the cervical spine for the treatment of various injury and disease issues, while the head is supported by the pillow in the correct postural alignment, producing the most effective mechanical traction possible. This gentle mechanical traction can be applied while awake, or asleep. Gentle mechanical traction while sleeping is much more effective in providing long term pain relief and correcting posture thanks to the relaxed state of the muscles. Mechanical traction applied to the cervical spine while the user 64 sleeps is the most effective mechanical traction possible because the body is completely relaxed during sleep. This relaxed state means the muscles are in relaxed state decreasing the resistance to the positive effect of the mechanical traction.

The mechanical traction assembly 44 may include a planar base 46 supporting two spaced apart base uprights 48 onto each a bar assembly upright 52 may telescopically engage so that a pin 56 of each base upright 48 may removably lock with one of a plurality of spaced apart assembly upright holes 54 to selectively adjust the elevation of spaced apart bars 58 extending between the assembly uprights 52. A user 64 may attached a fastener 60 to a preferred bar 58 so that a neck strap/harness 62 may provide mechanical traction to their head resting in the head cutout 12. In certain embodiments, the user's head may be resting on the first and/or second cervical modules 20 and/or 30 depending on the size and shape of the user 64. If the user 64 is large, they may require more thickness and support under their head during sleep and/or mechanical traction.

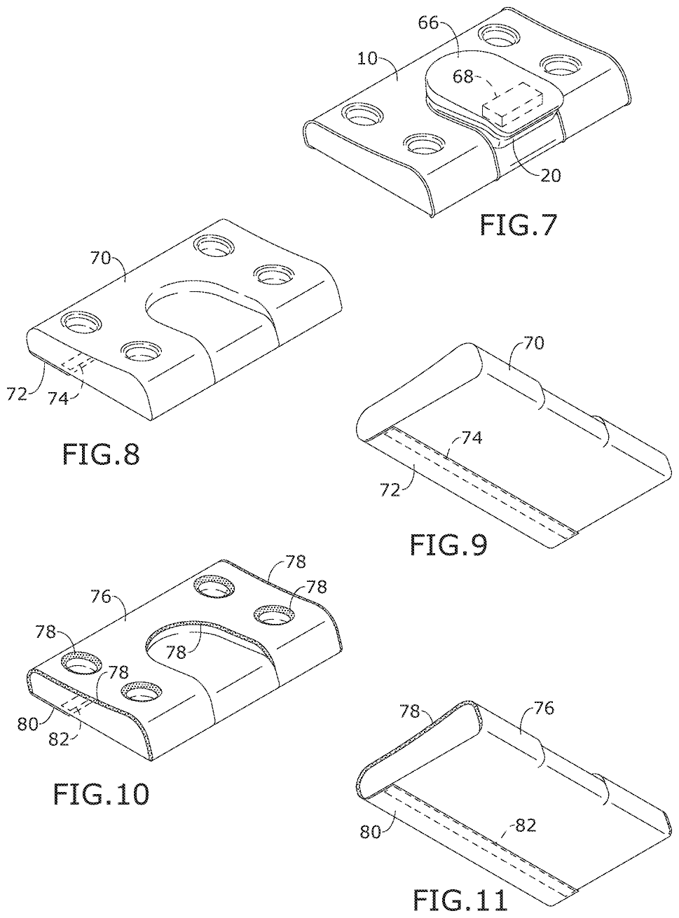

Referring to FIG. 7, the vibration module 66 may be dimensioned and adapted to be received in the head cutout 12 or over the first cervical module 20. The vibration module 66 may provide a power source 68.

Referring to FIGS. 8 and 9, a stretch hypoallergenic pillowcase 70 may be applied over the finished, customized pillow—i.e., the main module 10 and any applied modules. This further secures the positions of any customized, applied modules. It also prevents the infestation of allergens such as bed bugs and dust mites, among others. The stretch hypoallergenic pillowcase 70 may be made of material that prevents the passage of moisture and sweat through to the surface of the modules. The material may also be allergen free and prevents the infestation of bed bugs, while resisting dust mites.

The stretch hypoallergenic pillowcase 70 may be made of a cotton polyester blend material with a four way stretch. The stretch hypoallergenic pillowcase 70 may include a closure flap 72 and removably fasteners 74, such as hook and loop fasteners, for removably securing the closure flap 72. The stretch hypoallergenic pillowcase 70 may slide over the entire customized pillow structure just as a typical pillowcase slides over a common pillow, however the four way stretch characteristics of the stretch hypoallergenic pillowcase 70 further secures the positions of modules.

Referring to FIGS. 10 and 11, a cool mesh cover 76 may be applied over the stretch hypoallergenic pillowcase 70, providing an air gap to allow the movement of air and prevent heat buildup. The cool mesh cover 76 may be made of a breathable mesh material designed to prevent the buildup of heat. The cool mesh cover 76 may provide mesh section 78 that align with the periphery of the cutouts 12,14,16 as well as the periphery of the ends of the main module 10. The cool mesh cover 76 may include a closure flap 80 and removably fasteners 82, such as hook and loop fasteners, for removably securing the closure flap 80.

The present invention may embody a computer implemented video assistant for guiding users in the application of the modules in their relative location, positioning, and configurations to produce the customized finished pillow that is unique to anyone's own body size, and shape. This provides a level of comfort common pillows cannot provide. The modules can be applied to the pillow in unlimited positions and configurations to allow the user to create the pillow that best aligns their unique body. The resulting customized pillow also aligns the spine in the proper anatomical position relative to the user.

As mentioned above, the components can be configured in unlimited configurations to meet the needs of the user. The components can also be reconfigured to allow the pillow to be used for support and comfort of various other body parts such as a knee bolster, lumbar support, leg elevation, prone lying support, and various other uses. The pillow components can also be configured to provide support during all stages of pregnancy. The components may also be combined to provide chest elevation for various breathing issues, as well as the improvement of sleep apnea, and/or elimination of snoring.

The various features and modules work together to accommodate the wide range of shapes and sizes of users. Using the provided arrangement guide, the user determines the placement of the various modules and applies them to the main module 10 in such a manner as to allow for the proper alignment of the spine, relaxation of the muscles, unimpeded flow of oxygen and blood, proper conduction of nerve impulses, and as a result, the most restful and restorative sleep possible. The placement of modules onto the main module 10 is determined by the user based on their body size, shape, and sleep style. Once the user has applied the modules to the main module 10, they will test the placement to assure proper alignment as outlined in the provided arrangement guide. The ear cutouts 14 and 16, 24 and 26, and 34 and 36 are built into some modules to assist in the placement and alignment of the modules. The user may or may not use all of the modules. The user may or may not then apply the mesh cover 76/pillowcase 70 to the assembled modules to protect from make-up, hair spray, body odors, body oils, etc.

A method of manufacturing the present invention requires the manufacture of specialized tooling specific to each module. The tooling may be designed using various methods such as 3D CAD Software, hand drawing, etc. The tooling must be precisely cut/milled using various methods. It may be cut by craftsman using hand-held tools or milled by precise machines. It can be cut from various materials such as steel, aluminum, stainless steel, and others. The custom tooling is then used on specialized manufacturing equipment for the production of the memory foam core of each module. Each module of the present invention may be produced individually. Liquid foam may be injected inside the tooling cavity and it expands to fill the unique shape of the void within the tool creating the foam core of the module. The liquid foam begins to harden very quickly and the module is removed from the tooling and placed on large racks to cure. Once the foam is sufficiently cured, a manufactured and/or hand sewn cover designed to fit the module tightly is applied over the foam to protect the foam, provide a soft comfortable surface for the user to place their head on, and to attach the module to the main module as needed.

And so, a method of using the present invention may include the following. The components disclosed above may be provided. A user 64 may selectively configure their own desired unique pillow based on the size and shape of their own unique body. The user can quickly and easily add or remove modules to create a finished pillow that fits their body size, shape, and sleep style. Once they have used the application guide to create the pillow that most effectively aligns their body to relieve pressure and allow total relaxation no matter if they sleep on their side, back, or both, they may never have to adjust the pillow again. The adjustments the user makes are specific to their sleep style so if they are a back sleeper, they will adjust the cervical support area of the pillow designed for back sleepers. If they are a side sleeper, they will adjust the side sleeper area of the pillow designed specifically for side sleepers. If they sleep on both their side and back, they can adjust both areas individually so that when they turn from either side to their back, or from their back to either side, they will have the perfectly customized area to accommodate their head so that they can achieve the deepest most restorative sleep possible.

The attachment of the various modules, in unlimited configurations, allows the user to modify the shape of the pillow, and also the height of the pillow. Whether the user 64 is 6′4″ tall or 4′3″ tall, they can “construct’ their own pillow to provide the exact support their body needs in the exact locations and sizes their body requires. This also allows for the proper positioning and alignment of the spine to align the body in the anatomically correct position. No other pillow allows for this level of customization.

Additionally, various adaptable configurations of the present invention can be used by hospitals to accommodate their patients in their rooms. Each patient is unique and the pillow in their room can be easily and quickly configured to their body shape and size to provide the most comfortable positioning possible during recovery. Increased comfort can speed up recovery, relieve pressure to reduce the incidence of bed sores, and improves outcomes. The adaptable present invention can also be used in surgical settings to support and align the patient to improve the surgeon's access to the area being operated on while also providing optimal support for the patient, during the surgery. The present invention can also be used by the hotel industry to allow hotel guests to adapt the bed pillow to their personal body shape and size. The present invention can be produced in various sizes such as a children's version, and a travel version. Multiple variations of the unique pillow allow use as a seat cushion or bolster for use in wheelchairs. Further variations can be used to support and align the thoracic, and lumbar regions of the spine, as well as configurations specific to those who sleep on their stomach, or exclusively on their side.

It should be understood, of course, that the foregoing relates to exemplary embodiments of the invention and that modifications may be made without departing from the spirit and scope of the invention as set forth in the following claims.

What is claimed is:

1. A customizable pillow for combining pillow modules for selectively improving restfulness and providing neck and spine treatment applications, comprising:
a main pillow module having an upper surface extending longitudinally between two ends and between a proximal edge and a distal edge;
a head cutout communicating with the proximal edge, the head cutout dimensioned to receive a human head; and
one or more ear cutouts along the upper surface on each side of the head cutout.

2. The customizable pillow for combining pillow modules for selectively improving restfulness and providing neck and spine treatment applications of claim 1, further comprising a plurality of modules dimensioned to be securely received in the head cutout.

3. The customizable pillow for combining pillow modules for selectively improving restfulness and providing neck and spine treatment applications of claim 2, wherein the plurality of modules include an acupressure module and a vibration module.

4. The customizable pillow for combining pillow modules for selectively improving restfulness and providing neck and spine treatment applications of claim 3, wherein the acupressure module provides acupressure nodes along a proximal edge thereof.

5. The customizable pillow for combining pillow modules for selectively improving restfulness and providing neck and spine treatment applications of claim 1, further comprising one or more cervical modules dimensioned to be securely received in the head cutout, whereby the one or more cervical modules protrude above the upper surface of the main pillow module.

6. The customizable pillow for combining pillow modules for selectively improving restfulness and providing neck and spine treatment applications of claim 5, further comprising two or more side modules and one or more rear modules, each side module and rear module providing at least one side or rear ear cutout.

7. The customizable pillow for combining pillow modules for selectively improving restfulness and providing neck and spine treatment applications of claim 5, further comprising a mechanical traction assembly for operatively associating the main pillow module for providing mechanical traction to a human user laying a head in the head cutout or on one or more cervical modules.

8. The customizable pillow for combining pillow modules for selectively improving restfulness and providing neck and spine treatment applications of claim 5, further comprising a cool mesh cover dimensioned to envelope the main pillow module so as to provide mesh sections along a periphery of each ear cutout, the head cutout, and both ends of the main pillow module, respectively.

9. A customizable pillow for combining pillow modules for selectively improving restfulness and providing neck and spine treatment applications, comprising:
a main pillow module having an upper surface extending longitudinally between two ends and between a proximal edge and a distal edge;
a head cutout communicating with the proximal edge, the head cutout dimensioned to receive a human head;
one or more ear cutouts along the upper surface on each side of the head cutout;
a plurality of modules dimensioned to be securely received in the head cutout, wherein the plurality of modules include an acupressure module and a vibration module, wherein the acupressure module provides acupressure nodes along a proximal edge thereof;
one or more cervical modules dimensioned to be securely received in the head cutout, whereby the one or more cervical modules protrude above the upper surface of the main pillow module;
two or more side modules and one or more rear modules, each side module and rear module providing at least one side or rear ear cutout;
a mechanical traction assembly for operatively associating the main pillow module for providing mechanical traction to a human user laying a head in the head cutout or on one or more cervical modules; and
a cool mesh cover dimensioned to envelope the main pillow module so as to provide mesh sections along a periphery of each ear cutout, the head cutout, and both ends of the main pillow module, respectively.
